(19) United States
(12) Patent Application Publication
(10) Pub. No.: US 2009/0029565 A1
(43) Pub. Date: Jan. 29, 2009

(54) Socket for a Towing Apparatus

(75) Inventors: Jens MUELLER, Backnang (DE); Dirk VAHLE, Ennigerloh (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 12/163,619

(22) Filed: Jun. 27, 2008

(30) Foreign Application Priority Data
Jun. 30, 2007 (DE) 102007030537.2-21

(51) Int. Cl. H01R 33/00

(52) U.S. Cl. 439/35

(57) ABSTRACT

A socket for a towing apparatus for releasably coupling a motor vehicle trailer, includes a housing having a front housing section for receiving a trailer-side plug-in connector and a cable outlet for motor vehicle-side cabling. A first axis of the housing extends in the insertion direction of the plug-in connector, and a second axis extends axially with respect to the cable outlet. The two axes enclose an angle which is less than 180°.

### BACKGROUND AND SUMMARY OF THE INVENTION

This application claims the priority of German patent document 10 2007 030 537.2-21, filed Jun. 30, 2007, the disclosure of which is expressly incorporated by reference herein.

The invention relates to a socket for at owing apparatus for releasably fixing a motor vehicle trailer.

Sockets for towing devices are known, in which the socket can be fixed to a carrying element of the towing device, and has a housing with a front housing section for receiving a trailer-side plug-in connector. A rear housing section is configured as a cable outlet for motor vehicle-side cabling, which cabling is connected to the socket extending in the region of the cable outlet, substantially parallel to an insertion direction of the trailer-side plug-in connector.

In a socket of this type, it is considered disadvantageous that the amount of installation space required by the extent of the socket in the insertion direction of the plug-in connector necessitates a comparatively great horizontal extent of the carrying element of the towing apparatus.

One object of the present invention is to provide a socket of the type mentioned above, which accommodates a towing apparatus with a more compact overall form than in the prior art.

This and other objects and advantages are achieved by the socket according to the invention, in which the housing of the socket has a front housing section for receiving a trailer-side plug-in connector and a cable outlet for motor vehicle-side cabling. The housing has a first axis which extends in the insertion direction of the plug-in connector and, together with a second axis which extends axially with respect to the cable outlet, encloses an angle which is less than 180°.

The second axis extends axially with respect to the cable outlet, which is angled away in relation to the first axis. This arrangement enables the housing of the socket to have a smaller extent in the insertion direction of the trailer-side plug-in connector in comparison with the prior art. It thus makes it possible to configure a towing apparatus with a smaller horizontal extent of the carrying element in comparison with the prior art, and therefore a more compact overall shape of the towing apparatus.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a towing apparatus for a motor vehicle trailer which has a socket according to the prior art;

FIG. 2 shows a towing apparatus for a motor vehicle apparatus which has a socket according to the invention; and

FIG. 3 shows the socket according to the invention in a perspective view from the side, in a perspective view from above and in a view of a cable outlet of the socket.

### DETAILED DESCRIPTION OF THE DRAWINGS

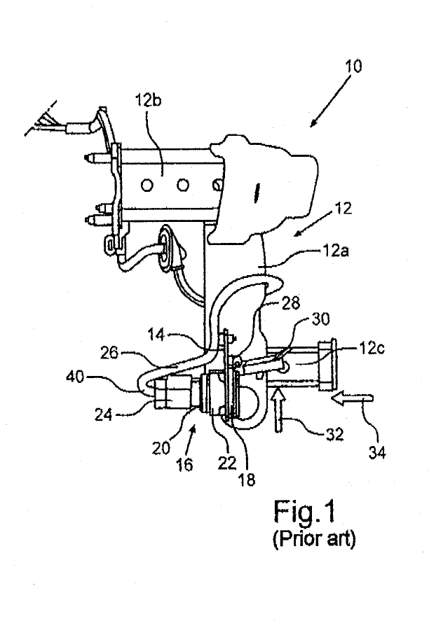

FIG. 1 shows a known towing apparatus 10 for the releasably attaching of a motor vehicle trailer. A carrying element 12 of the towing apparatus 10 comprises a branch 12a, which extends substantially vertically in the state in which it is mounted on a motor vehicle, and two substantially horizontally extending branches 12b and 12c. The vertically extending branch 12a has a holding plate 14. A socket 16 which is configured according to the prior art has a fastening plate 18 which is fixed on the holding plate 14, for example by means of screws. A housing 20 of the socket 16 comprises a front housing section 22 and a cable outlet 24 for vehicle-side cabling 26.

A socket cover 30, which can be moved from a closed position into an open position (shown) is arranged on an upper longitudinal edge 28 of the fastening plate 18. A corresponding opening direction 32 of the socket cover 30 is indicated by an arrow in FIG. 1 to FIG. 3.

The front housing section 22 of the socket 16 is designed to receive a trailer-side plug-in connector (not shown in the present case), and it is possible to insert the trailer-side plug-in connector into the front housing section 22 in an insertion direction 34 which is symbolized by an arrow in FIG. 1.

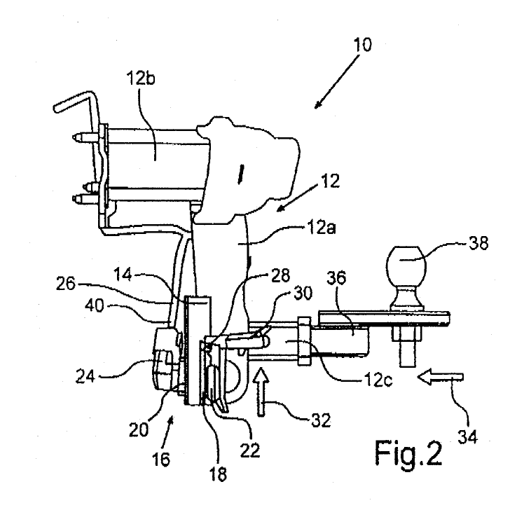

It can be seen, in particular in combination with FIG. 2, that the substantially horizontally extending branch 12c of the carrying element 12 is designed for fixing a holding device 36 for a coupling ball 38.

Moreover, it can also be seen in FIG. 2 that the cable outlet 24 of the socket 16 is angled away in relation to the front housing section 22. Here, the cable outlet 24 points approximately in the opening direction 32 of the socket cover 30. In other words, the cable outlet 24 points substantially vertically upwards when the towing apparatus 10 is mounted on the motor vehicle.

It becomes clear in combination with FIG. 1 that the socket 16 which is shown in FIG. 2 has a considerably smaller extent in comparison with the prior art in the insertion direction 34 of the trailer-side plug-in connector. Accordingly, the towing apparatus 10 according to FIG. 2 has a more compact overall form in comparison with the prior art with a smaller extent of the substantially horizontally extending branch 12b of the carrying element 12. As a result of the angling away of the cable outlet 24 of the socket 16 according to FIG. 2, the socket 16 together with a section 40 of the vehicle-side cabling 26 which adjoins the cable outlet 24 directly is approximately 45 mm shorter than the socket 16 according to FIG. 1 which is known from the prior art. As a result of advantages in the packaging of the towing apparatus 10 according to FIG. 2, this improves its installation space situation considerably.

Moreover, it can be seen from FIG. 2 in combination with FIG. 1 that, in the socket according to FIG. 2, the probability of damage to that section 40 of the vehicle-side cabling 26 which adjoins the cable outlet 24 directly is reduced by angling away the cable outlet 24. When the towing apparatus 10 is mounted on the motor vehicle, the section 40 is situated in the overhang region of the motor vehicle in the case of the socket 16 from FIG. 1 according to the prior art. The section 40 is therefore exposed more readily to damage as a result of grounding or getting caught in the terrain in the case of the socket 16 from FIG. 1 according to the prior art.

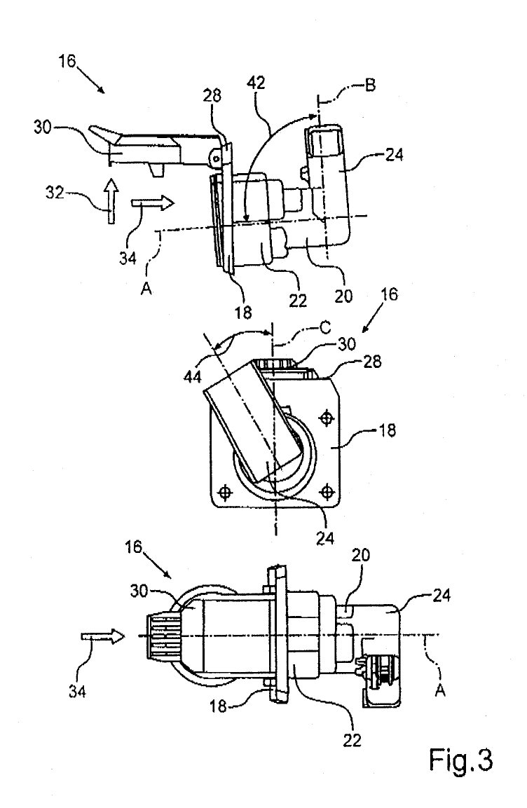

As shown in from the illustrations of the socket 16 according to FIG. 2 in three views of FIG. 3, an angle which is enclosed by a first axis A of the housing 20 which extends in the insertion direction 34 and by a second axis B which extends axially with respect to the cable outlet 24 has a value of approximately 90°. In alternative embodiments of the socket 16 according to FIG. 2, the angle 42 can have, for example, values between 179° and 65°.

It can be gathered from the view according to FIG. 3 of the cable outlet 24 of the socket 16 counter to the insertion direction 34 of the trailer-side plug-in connector, that the cable outlet 24 is configured such that it can be rotated about the first axis A of the housing 20 with respect to the front housing section 22. The cable outlet 24 can therefore be moved in relation to a center axis C of the fastening plate 18 about an angle 44 of up to 360° out of the substantially upwardly pointing direction in the state of the towing apparatus 10, in which it is mounted on the motor vehicle. The cable outlet 24 can therefore ensure an improvement in the installation space situation of the towing apparatus 10 both by its being angled away and by its three-dimensional orientation.

It can be seen, in particular, from the perspective view of the socket 16 from above onto the cable outlet 24 according to FIG. 3 that the cable outlet 24 can be designed for receiving a motor vehicle-side plug-in connector.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A socket for a towing apparatus for releasably coupling a motor vehicle trailer wherein:
a housing of the socket has a front housing section for receiving a trailer-side plug-in connector, and a cable outlet for motor vehicle-side cabling; and
a first axis of the housing, which extends in an insertion direction of the plug-in connector, and a second axis which extends axially with respect to the cable outlet, enclose an angle which is less than 180°.

2. The socket according to claim 1, wherein said angle has a value from 179° to 65°.

3. The socket according to claim 2, wherein the cable outlet is configured such that it is rotatable about the first axis of the housing with respect to the front housing section.

4. The socket according to claim 1, wherein the cable outlet points substantially vertically upwards in a state of the towing apparatus, in which it is mounted on a motor vehicle.

5. The socket according to claim 1, wherein the cable outlet is structured to receive a motor vehicle-side plug-in connector.
